(19) United States
(12) Patent Application Publication
(10) Pub. No.: US 2025/0203338 A1
(43) Pub. Date: Jun. 19, 2025

(54) MULTI-LINK ROAMING ACROSS MULTIPLE PHYSICAL APS IN WI-FI NETWORKS

(71) Applicant: Cisco Technology, Inc., San Jose, CA (US)

(72) Inventors: Jerome Henry, Pittsboro, NC (US); Robert Barton, VANCOUVER (CA); Indermeet Gandhi, San Jose, CA (US)

(21) Appl. No.: 18/607,145

(22) Filed: Mar. 15, 2024

Related U.S. Application Data
(60) Provisional application No. 63/612,348, filed on Dec. 19, 2023.

(51) Int. Cl. H04W 8/02; H04W 84/12

(52) U.S. Cl. CPC H04W 8/02; H04W 84/12

(57) ABSTRACT

Embodiments described herein allow for the improvement of roaming in a multi-link and/or multi-access point (AP) environment. The needs of a wireless device or applications operating on the wireless device can dictate what types of connections are desired. These needs can be encapsulated within an objective function, which can dictate an overall roaming strategy associated with a network device or associated application. This objective function can allow for various APs to suggest, or wireless network devices to request, different target roaming AP candidates based on an implicit or explicit criteria. This criteria can be focused on maximizing throughput, or minimizing loss, or a specific combination of other needs. The objective function can be determined by the wireless network device, the AP, or a remote device such as a wireless local area network controller, or cloud-based network management service. The objective function can also be dynamically adjusted based on subsequent events.

### CROSS-REFERENCE TO RELATED APPLICATION

This application claims the benefit of U.S. Provisional Patent Application No. 63/612,348, filed Dec. 19, 2023, which is incorporated by reference herein in its entirety.

The present disclosure relates to wireless networking. More particularly, the present disclosure relates to improving roaming in a multi-link and/or multi-access point environments.

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Specifically, Wi-Fi 8 networks aim to provide uninterrupted high-bandwidth connectivity to users and devices roaming rapidly across multiple APs by exploiting multiple simultaneous connections. With Multi-Link Operation (MLO) introduced in 802.11be, a network device, such as an end user device can associate to the same AP using multiple links. Without intelligent coordinated decision making between APs and end user devices on the ideal multi-link roaming approach tailored to each network device's needs and capabilities, opportunities to maximize performance may be lost.

### SUMMARY OF THE DISCLOSURE

Systems and methods for improving roaming in multi-link and/or multi-access point environments in accordance with embodiments of the disclosure are described herein. In some embodiments, a device includes a processor, at least one wireless transceiver configured to provide access to a network, and a memory communicatively coupled to the processor, wherein the memory includes a multi-link roaming logic that is configured to indicate support for multi-link operations to a network device, receive a response from the network device indicating multi-link capabilities, develop a recommendation list for the network device, evaluate one or more network conditions, and generate an objective function associated with the network device.

In some embodiments, the multi-link roaming logic is further configured to determine that a roaming recommendation is required.

In some embodiments, the determination of the roaming recommendation is based on receiving a request for a recommendation.

In some embodiments, the request for a roaming recommendation is received from the network device.

In some embodiments, the roaming recommendation determination is based on a recommendation event occurring.

In some embodiments, the roaming recommendation event is detecting a change in a movement of the network device.

In some embodiments, the multi-link roaming logic is configured to receive the objective function from the network device.

In some embodiments, indicating support for multi-link operations occurs by modifying an extended capabilities element within a beacon frame.

In some embodiments, the roaming recommendation list is a weighted target access point (AP) list.

In some embodiments, the weighted target access point AP list is developed based on one or more criteria.

In some embodiments, the one or more criteria includes at least one of link reliability, maximized throughput, roaming latency, band constraints, frame jitter constraints, or frame delay constraints.

In some embodiments, the objective function is configured to indicate one or more roaming strategies.

In some embodiments, the one or more roaming strategies are associated with a selection of links and access points during a roaming process.

In some embodiments, at least one network interface is configured to provide access to a network, and a memory communicatively coupled to the processor, wherein the memory includes a multi-link roaming logic that is configured to receive an indication for multi-link operations from a network device, transmit a response indicating multi-link capabilities, generate an objective function, transmit the objective function to the network device, request a roaming recommendation, and receive a roaming recommendation.

In some embodiments, the roaming recommendation is based on at least the objective function.

In some embodiments, the roaming recommendation is configured to indicate one or more links to establish a network connection to.

In some embodiments, the objective function is configured to indicate if roaming recommendations should prioritize multi-link operations or single-link operations.

In some embodiments, the objective function is configured to indicate if roaming recommendations should prioritize single access point connections or multi-access point connections.

In some embodiments, indicating multi-link capabilities occurs by modifying an extended capabilities element within a response frame.

In some embodiments, a method of managing multi-link wireless network connections includes indicating support for multi-link operations to a network device, receiving a response from the network device indicating multi-link capabilities, developing a recommendation list for the network device, evaluating one or more network conditions, receiving an objective function from with the network device, and modifying one or more recommendations provided from the recommendation list in response to the received objective function.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic block diagram of a call flow in a power management system, in accordance with various embodiments of the disclosure;

FIG. 3 is a conceptual network diagram of various environments that a multi-link roaming logic may operate on a plurality of network devices, in accordance with various embodiments of the disclosure;

FIG. 4 is a conceptual illustration of a wireless network environment with a plurality of access points suitable for roaming in accordance with various embodiments of the disclosure;

FIG. 5 is a flowchart depicting a process for multi-link roaming in accordance with various embodiments of the disclosure;

FIG. 6 is a flowchart depicting a process for access point multi-link roaming management in accordance with various embodiments of the disclosure;

FIG. 7 is a flowchart depicting a process for end user device multi-link roaming management in accordance with various embodiments of the disclosure;

FIG. 8 is a flowchart depicting a process for remote-based multi-link roaming management in accordance with various embodiments of the disclosure;

FIG. 9 is a flowchart depicting a process for roaming recommendation processing in accordance with various embodiments of the disclosure; and

FIG. 10 is a conceptual block diagram of a device suitable for configuration with a multi-link roaming logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to optimize roaming in a multi-link operation (MLO) and multi-access point (AP) environment. In many embodiments, various exchanges (such as, but not limited to, basic service set transition management (BTM), like in 802.11v BTM) can be enhanced to allow the end user device to request, and the AP to suggest, different target roaming AP candidates based on implicit or explicit criteria (throughput maximization, loss minimization, etc.) Such enhancement provides for higher reliability by adapting the roaming candidates to the end user device's particular needs.

Multiple Link Operation (MLO) is a concept in wireless networking, especially in scenarios where high reliability, improved throughput, or load balancing are required. In essence, MLO can involve the simultaneous use of multiple wireless links to enhance the overall performance of a network connection. This technique is particularly useful in situations where a single link or other single-link operations may not provide sufficient bandwidth or reliability, or where redundancy and fault tolerance are essential.

One of the primary objectives of MLO is to mitigate the limitations of a single wireless link, such as interference, fading, or congestion, by utilizing multiple links simultaneously. By distributing the traffic across multiple links, MLO can improve the overall throughput and reliability of the network connection. This approach is especially beneficial in environments with high interference levels or dynamic channel conditions, where relying on a single link or other single-link operations may result in degraded performance.

In MLO, the network infrastructure typically consists of multiple access points or nodes, each equipped with multiple radios or antennas. These access points collaborate to establish and maintain multiple links with the client device or among themselves. The distribution of traffic across these links can be dynamically adjusted based on factors such as link quality, traffic load, and network conditions.

There are several strategies for implementing MLO, including link aggregation, spatial diversity, and load balancing. Link aggregation can involve combining the bandwidth of multiple links to create a virtual link with higher capacity. Spatial diversity exploits the spatial dimension by using multiple antennas to transmit and receive signals, thereby improving signal strength and reliability. Load balancing distributes traffic across multiple links to optimize resource utilization and prevent congestion on individual links.

MLO is particularly relevant in wireless networks deployed in challenging environments, such as urban areas with high user density or industrial settings with electromagnetic interference. By harnessing the capabilities of multiple links, MLO can enhance the performance, reliability, and scalability of wireless networks, enabling them to meet the demanding requirements of modern applications and services. Moreover, MLO plays a role in emerging technologies such as 5G and beyond, where achieving high data rates, low latency, and seamless connectivity are paramount.

Utilizing MLO to connect to multiple access points in wireless networking can involve a systematic approach aimed at enhancing the overall performance and reliability of the network connection. The process can begin with the identification of available access points within the device's range. Through scanning techniques provided by the wireless network interface, the device can detect nearby access points along with their signal strengths and supported network configurations. This initial step is for determining the available options for establishing multiple links.

Once the access points are identified, the device may proceed to establish connections with multiple access points simultaneously. This is achieved by configuring the wireless interface to associate with each access point using distinct network interfaces or radio channels. By establishing multiple links, the device can gain access to a broader range of resources and opportunities for data transmission.

Load balancing plays a role in MLO, as it enables the device to distribute traffic effectively across the established links. Load balancing algorithms consider factors such as link quality, signal strength, and available bandwidth to determine the optimal distribution of traffic. This ensures that the network resources are utilized efficiently, maximizing throughput, and minimizing congestion on individual links.

Seamless roaming is another essential aspect facilitated by MLO. As the device moves within the coverage area, it can dynamically switch between access points while maintaining the established links. This seamless handover ensures uninterrupted connectivity and optimal performance, even as the device transitions between different access points.

In environments with high interference or congestion, MLO can further enhance performance by employing channel bonding techniques. By combining multiple non-overlapping channels for data transmission, channel bonding increases the available bandwidth and reduces the likelihood of interference, resulting in improved overall performance.

Moreover, MLO provides built-in fault tolerance and redundancy by establishing multiple links to different access points. In case one link experiences degradation or failure due to interference or other issues, the device can seamlessly switch to another available link, ensuring continuous connectivity. This dynamic link management optimizes the overall performance and reliability of the network connection, making MLO an effective strategy for addressing the challenges of modern wireless connectivity in various environments.

Roaming is another aspect of wireless networking, enabling devices to maintain connectivity while transitioning between different access points or network cells. It facilitates uninterrupted access to network services as users move within the coverage area. Roaming is particularly critical for mobile devices like smartphones, tablets, and laptops, where continuous connectivity is essential for seamless user experiences.

In wireless networking, the roaming process unfolds through several stages. Initially, when a device connects to a wireless network, it associates with a specific access point or base station within its range. This association allows the device to access network resources and services provided by the access point, negotiating connection parameters such as authentication, encryption, and network settings.

As users move within the coverage area, their devices continuously monitor signal strength and quality. If the signal weakens or a stronger signal from another nearby access point is detected, the device considers initiating the roaming process to switch to a better connection. Through scanning operations, the device detects nearby networks, evaluates available access points, and selects the most suitable one for roaming.

Once a suitable access point is identified, the device initiates the handover process to transition from the current access point to the new one. This can involve sending a handover request to the new access point and negotiating connection parameters such as authentication and encryption keys. After the handover request is accepted, the device undergoes authentication and association procedures to establish a connection with the new network.

Once successfully associated with the new access point, data forwarding resumes, and the device can continue its network activities seamlessly. From the user's perspective, the transition is transparent, and they experience uninterrupted connectivity without noticeable interruptions.

Roaming protocols and standards, such as IEEE 802.11r (Fast BSS Transition), are designed to optimize the roaming process, reduce handover latency, and enhance the user experience in wireless networks. Through efficient roaming mechanisms, wireless networking enables users to stay connected regardless of their movement within the coverage area, ensuring seamless access to network services.

Roaming coordination in wireless networking can involve various methods aimed at managing and optimizing the handover process between different access points or network cells. One common approach is centralized roaming management, where a central entity such as a wireless controller or network management system oversees roaming activities across the network. This central controller maintains information about available access points, client devices, and network conditions, enabling it to make informed decisions regarding handovers based on factors such as signal strength, load balancing, and network policies.

Another method for roaming coordination is neighbor list exchange, where access points exchange information about neighboring access points and their signal characteristics. During the initial association process, access points provide clients with a list of neighboring access points, allowing clients to make informed roaming decisions based on the quality of available access points. This exchange of neighbor lists helps ensure seamless roaming transitions between neighboring cells without signal degradation or interruptions.

Inter-Access Point Protocol (IAPP) is another protocol used for roaming coordination, facilitating communication between access points in a wireless network. It allows access points to exchange information about connected clients, handover requests, and roaming policies. By leveraging IAPP, access points can coordinate handovers more effectively, enabling seamless roaming transitions for clients as they move between cells.

Fast roaming protocols, such as IEEE 802.11r (Fast BSS Transition), aim to minimize handover latency and authentication overhead during the roaming process. These protocols pre-authenticate clients with neighboring access points, allowing for faster reassociation and reduced handover delays. By pre-establishing security contexts and keying materials, fast roaming protocols enable clients to roam quickly between access points without experiencing noticeable interruptions or authentication delays.

Additionally, roaming coordination can be influenced by load balancing and mobility policies enforced by network administrators. These policies define criteria for triggering handovers, such as signal strength thresholds, client load balancing thresholds, or specific mobility patterns. By configuring load balancing and mobility policies, administrators can influence roaming decisions and ensure optimal resource utilization across the network.

Active link sessions in wireless networking refer to ongoing connections established between wireless devices and access points or between wireless devices themselves. These sessions represent the data transmission paths that enable communication between devices over the wireless medium. In active link sessions, data packets are exchanged between the transmitting and receiving devices, allowing for the transfer of information, such as files, messages, or multimedia content.

Each active link session can involve several key components, including the transmitting device, the receiving device, and the wireless infrastructure, such as access points or routers. When a device initiates communication, it establishes a link session with the intended recipient, typically by associating with an access point or directly connecting to another device. This link session remains active as long as the devices maintain connectivity and continue to exchange data packets.

Active link sessions play a role in facilitating various wireless networking applications and services, including internet browsing, streaming media, VoIP (Voice over Internet Protocol), online gaming, and file sharing. These sessions enable users to access network resources and communicate with others wirelessly, offering flexibility and mobility compared to wired connections.

The management and optimization of active link sessions are essential for ensuring efficient use of network resources and providing a seamless user experience. Techniques such as Quality of Service (QOS) mechanisms, traffic prioritization, and bandwidth management help prioritize and allocate resources to active link sessions based on their requirements. Additionally, protocols and standards governing wireless communication, such as IEEE 802.11 (Wi-Fi), define mechanisms for establishing, maintaining, and terminating active link sessions while ensuring data integrity, security, and reliability.

Moreover, as devices move within the coverage area or encounter changes in network conditions, active link sessions may undergo handovers or roaming transitions to maintain connectivity and adapt to the evolving environment. Seamless handover mechanisms, such as fast roaming protocols, enable devices to switch between access points or cells without interrupting active link sessions, ensuring uninterrupted communication and minimizing service disruption for users.

Client devices in wireless networks often have diverse needs and requirements based on their usage scenarios, mobility patterns, and application demands. Understanding these varying needs is often important for designing and managing wireless networks effectively. Two common scenarios that illustrate different client device needs are those of mobile clients moving across different areas and clients running applications requiring high throughput or low latency.

For mobile clients moving across different areas, seamless connectivity and efficient handover mechanisms are essential. These clients may include smartphones, tablets, laptops, or IoT devices carried by users or deployed in dynamic environments. As these devices transition between access points or cells within the network, they require continuous connectivity to maintain ongoing sessions, such as voice calls, video streams, or data transfers. Roaming mechanisms, including fast handover protocols and neighbor list exchanges, enable these mobile clients to switch between access points or cells seamlessly without experiencing service interruptions or degradation in performance. Additionally, mobility management techniques, such as predictive handover algorithms or adaptive roaming policies, help optimize handover decisions and ensure a smooth transition for mobile clients as they move across different areas within the coverage area.

On the other hand, client devices running applications that demand high throughput or low latency have specific requirements related to data transmission and network performance. Examples of such applications include real-time multimedia streaming, online gaming, video conferencing, and high-definition video surveillance. For these clients, achieving reliable and high-performance connectivity is paramount to deliver a seamless user experience. Quality of Service (QOS) mechanisms play a critical role in prioritizing traffic and allocating network resources to meet the needs of these high-throughput or low-latency applications. Traffic prioritization, bandwidth reservation, and traffic shaping techniques ensure that critical data streams receive preferential treatment, resulting in reduced latency, minimized packet loss, and optimized throughput for these applications. Moreover, network optimizations such as channel bonding, beamforming, and MIMO (Multiple Input Multiple Output) technology can enhance data rates and spectral efficiency, further improving the performance of high-throughput applications.

Generating roaming recommendations for end-user devices can involve considering various criteria to ensure seamless connectivity and optimal performance as devices move within the network coverage area. These criteria encompass factors such as link reliability, throughput maximization, minimum basic rate (MBR), make before break status, roaming latency, band constraints, frame jitter constraints, delay constraints, and others. By analyzing these criteria, network management systems or controllers can determine the most suitable access point for a device to roam to, enhancing the user experience and maintaining network efficiency.

Link reliability is a critical factor in roaming recommendations, as it determines the stability and robustness of the wireless connection. Roaming decisions may prioritize access points with stronger signal strength, lower interference levels, and higher signal-to-noise ratios to ensure reliable communication. By selecting access points with better link quality, roaming recommendations can minimize packet loss, reduce retransmissions, and enhance the overall reliability of the connection, particularly important for real-time applications such as VOIP or video streaming.

Maximizing throughput is another key consideration in roaming recommendations, especially for devices running bandwidth-intensive applications or requiring high-speed data transfers. Access points with higher data rates, wider channel bandwidths, or less congestion may be favored to ensure optimal throughput for the device. By selecting access points capable of providing higher throughput, roaming recommendations can improve the performance of data-intensive applications and support bandwidth-hungry services effectively.

Minimum Basic Rate (MBR) is a threshold data rate below which devices may experience degraded performance or connectivity issues. Roaming recommendations may prioritize access points offering MBR levels that meet or exceed the device's requirements to ensure reliable and consistent data transmission. By considering MBR constraints, roaming decisions can prevent devices from associating with access points offering suboptimal data rates, thereby maintaining satisfactory connectivity and performance.

Roaming latency is another critical factor in roaming recommendations, particularly for applications sensitive to delays, such as online gaming or VoIP. Access points with lower handover latency or faster authentication and association procedures may be preferred to minimize the interruption or degradation of ongoing sessions during the roaming process. By selecting access points with lower roaming latency, roaming recommendations can ensure seamless handovers and maintain the continuity of communication for time-sensitive applications.

Band constraints and frame jitter/delay constraints are additional considerations that may influence roaming recommendations, particularly in environments with multiple frequency bands or strict QoS requirements. Roaming decisions may take into account band availability, channel utilization, and frame delivery characteristics to optimize the selection of access points and ensure compliance with QoS constraints. By analyzing band constraints and frame jitter/delay constraints, roaming recommendations can meet the specific requirements of applications and services while maximizing network efficiency and performance.

In wireless networking, “make before break” refers to a seamless handover process in which a mobile device establishes a new connection with a target access point (AP) before breaking its existing connection with the current AP. This approach ensures uninterrupted connectivity for the device during the transition between APs, minimizing service disruptions and latency-sensitive applications' impact, such as voice calls or real-time streaming. During a “make before break” handover, the mobile device initiates the roaming process by scanning for available APs within its vicinity and identifying a suitable target AP based on predefined criteria such as signal strength, quality of service (QOS), and security parameters. Once a target AP is selected, the device begins the association process by sending association request frames to the target AP while still maintaining its connection with the current AP.

The target AP acknowledges the association request and negotiates connection parameters with the device, including authentication, encryption keys, and QoS settings. Upon successful negotiation and establishment of the new connection, the device begins forwarding data packets to the target AP while still receiving data from the current AP. Once the new connection with the target AP is established and validated, the device initiates the disassociation process with the current AP, signaling its intent to roam to the new AP. The current AP acknowledges the disassociation request and releases any resources allocated to the device, allowing it to complete the handover process smoothly. By adopting a “make before break” approach to handover, wireless networks can ensure seamless roaming experiences for mobile devices, minimizing service disruptions, and maintaining consistent connectivity during transitions between APs. This approach is particularly beneficial in environments with stringent latency requirements or applications sensitive to interruptions, where uninterrupted connectivity is essential for optimal user experience and productivity.

Extending MLO capability to connect links across separate physical APs can further enhance reliability and throughput during roaming by providing seamless transitions. However, effectively leveraging MLO across different APs to maximize performance poses several potential challenges depending on the configuration. For example, orchestrating coordinated end user device roaming across APs while maintaining active multi-link sessions is complex, requiring tight integration between infrastructure and end user devices. To that end, end user devices have diverse needs-high throughput end user devices desire to bundle links to the same AP, while highly mobile end user devices may require reliability across APs.

In many embodiments, an improved MLO roaming system may include having an AP indicate support for MLO roaming optimizations in the Extended Capabilities element of beacon frames and probe responses. For example, an end user device with the capability to connect links across physical APs may set a capability bit in the Extended Capabilities element when probing and associating to an AP, allowing the infrastructure to know of this capability. The serving AP, or a system behind the serving AP (e.g., WLC, predictive engine or other), develops a weighted target AP recommendation list for an end user device, based on criteria (e.g., link reliability, maximized throughput, MBBR, roaming latency, band constraints, frame jitter/delay constraints, or other). Historical factors, such as previous end user devices roaming records, CU over last intervals, QBSS Load IEs, can be used to predict the next best AP. In many embodiments, predictive algorithms may be utilized, along with criterion-specific predictions for the next best link.

It is envisioned that a roaming engine inside the end user device may be configured to determine an ideal tradeoff between bundling links to same AP vs splitting across APs for each end user device during roam events. Thus, in many embodiments, the roaming engine may determine the ideal MLO roaming objective function (OF). Examples of different OFs may including, by way of non-limiting example, high-speed AP-to-AP roaming (multi-AP MLO requirement); slow-speed, higher bandwidth roaming (single-AP, multi-radio MLO requirement); and high degree of UL and DL traffic symmetry (multi-AP, but STR mode requirement).

In many embodiments, a logic configured to determine the objective function may ultimately decide whether the MLO links of end user device should land on same AP (6 Ghz and 5 Ghz on same AP or whether the links needs to land on separate APs-6 Ghz on AP-1 and 5 Ghz on same AP-2 during roam-event). In additional embodiments, the roaming engine may determine the objective function to use for the end user device. In many embodiments, this execution may be (1) explicit—where the end user device already knows its roaming requirements based on programming, and/or (2) implicit, where the infra figures out the best objective function based on past behavior of the end user device and informs it accordingly. In the explicit case, the end user device informs the infrastructure of its MLO roaming OF. This could be done through a modified 802.11v BTM (BSS transition message), or an Action Frame—the intent is simply to communicate the infrastructure regarding how the end user device would like to roam in the MLO environment.

In the implicit case, the infra may examine the history of the end user device by analyzing roaming data in the past, how much data it transmitted and received, the symmetry of the data, etc. In many embodiments, based on the past analysis, it can determine the requirements of the end user device and informs it of the recommended roaming logic. In this case, an inventory of device types and their roaming profile may be maintained or otherwise stored, which will allow the roaming engine to predict the MLO roaming behavior of similar-type devices (such as AR/VR, or autonomous vehicles, etc.)

For example, the infrastructure may learn that an end user device is showing a high degree of persistent connectivity (like autonomous robots), and probably requires split link connections across separate neighbor physical APs are prioritized to maximize uptime during roams. However, for end user devices that demonstrate high throughput behavior, such as with respect to AR/VR devices, the infra may determine that joint links to same AP should be prioritized, with secondary lower weight backup links to other APs. In either case, this recommendation may be shared with the end user device so it can roam accordingly.

In many embodiments, in the explicit and/or implicit case, the infrastructure learns the objective function or the end user device. Based on this objective function, the wireless infra calculates a prioritized list of target APs and associated links as roaming candidates for the end user device, and how these should be handled for the end user device. For example, in additional embodiments, the end user device may request the AP for a next link recommendation. The request may augment 802.11vBTM, indicating the criteria the end user device is interested about. In another embodiment, the AP sends the recommendation, unsolicited, to the end user device, upon detecting specific conditions (rate shifting, RSSI drop etc.) In both cases, the serving AP communicates this weighted recommended AP list to the end user device by defining a Target AP Recommendation element included in BSS Transition Management Request frames.

In many embodiments, the new link specific Recommendation elements in BTM may contain a list of links on same or different APs with configurable weight values, based on the desired optimization approach for that end user device-whether the recommendation is to roam to single AP or roam using multiple links spread across 2 different APs. It should be appreciated that setting higher link weight values for links on the same target AP to recommend bundling links to that AP when optimizing for high throughput. Adjusting link weights to bias critical links to connect with different target APs is chosen when optimizing for ultra-reliable communications by splitting links across APs. For example, a BTM request from serving AP may suppress one of the links such that the end user device then selects links across two physical APs, thus achieving reliability.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

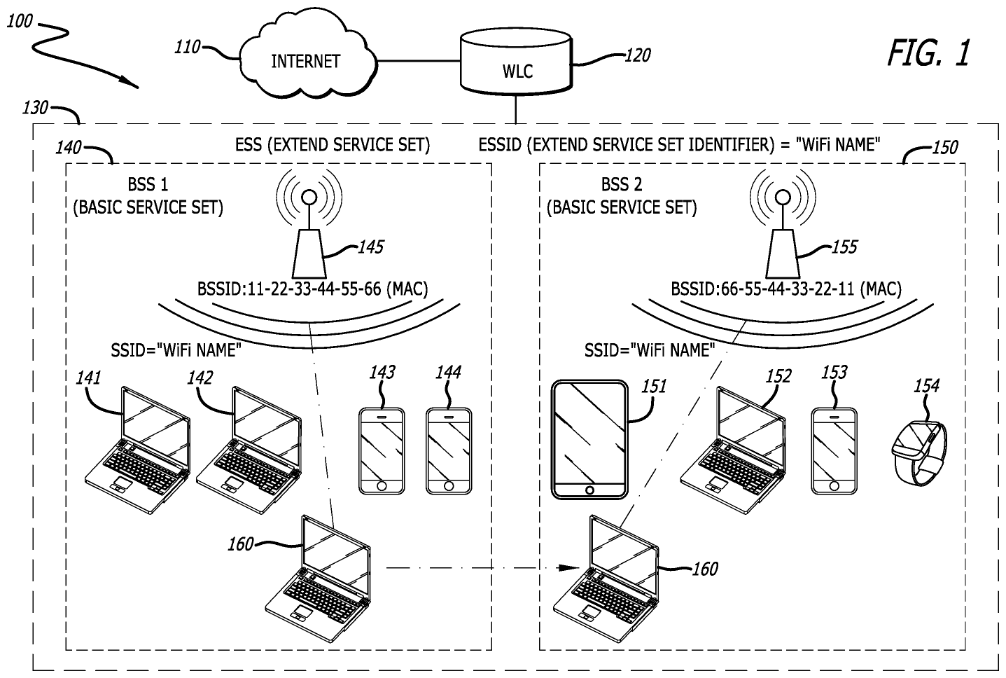

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

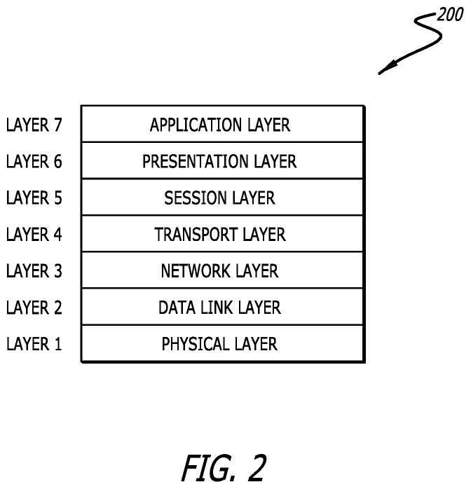

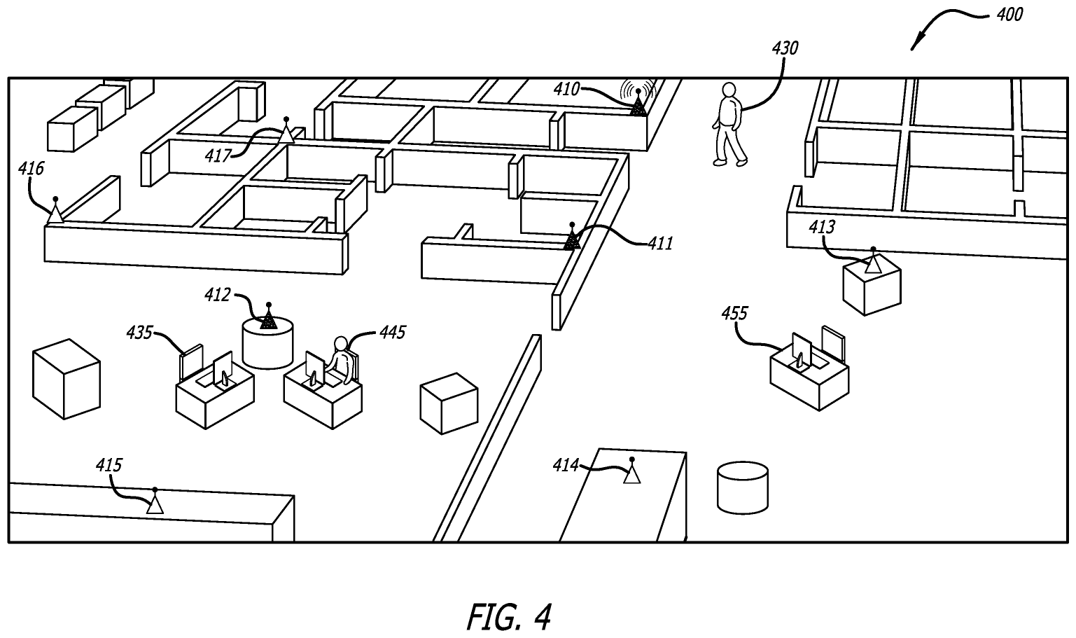

The network can include a variety of user end devices that connect to the network. These devices can sometimes be referred to as stations (i.e., “end user devices”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-10 as required to realize a particularly desired embodiment.

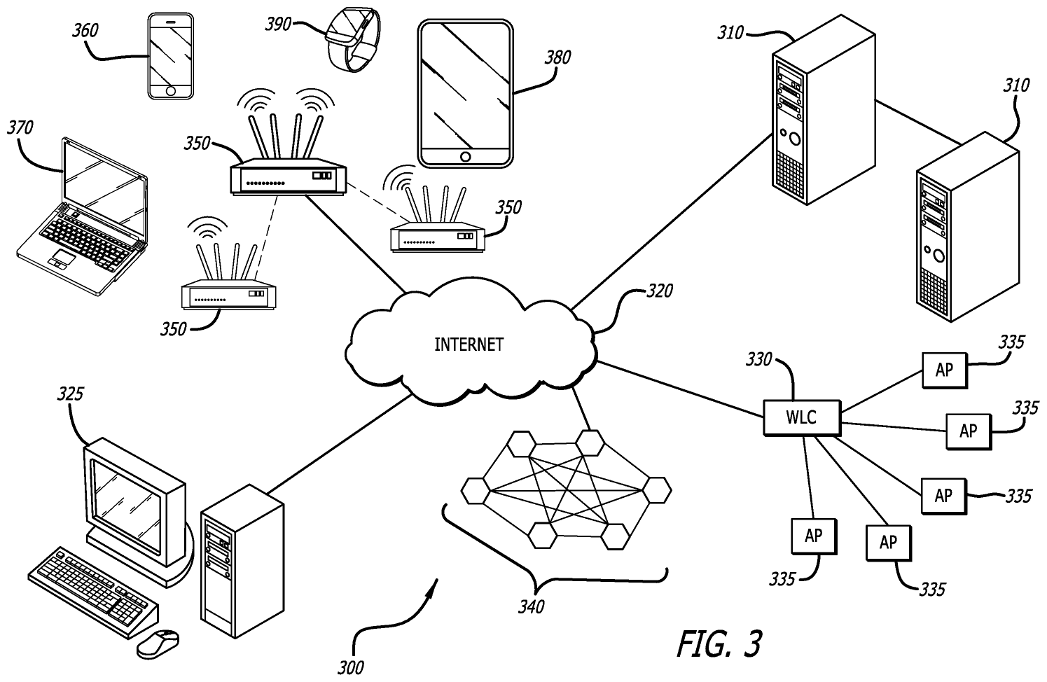

Referring to FIG. 3, a conceptual network diagram 300 of various environments that a multi-link roaming logic may operate on a plurality of network devices, in accordance with various embodiments of the disclosure is shown. Those skilled in the art will recognize that the multi-link roaming logic can include various hardware and/or software deployments and can be configured in a variety of ways. In many embodiments, the multi-link roaming logic can be configured as a standalone device, exist as a logic in another network device, be distributed among various network devices operating in tandem, or remotely operated as part of a cloud-based network management tool. In further embodiments, one or more servers 310 can be configured with the multi-link roaming logic or can otherwise operate as the multi-link roaming logic. In many embodiments, the multi-link roaming logic may operate on one or more servers 310 connected to a communication network 320 (shown as the “Internet”). The communication network 320 can include wired networks or wireless networks. The multi-link roaming logic can be provided as a cloud-based service that can service remote networks, such as, but not limited to a deployed network 340.

However, in additional embodiments, the multi-link roaming logic may be operated as a distributed logic across multiple network devices. In the embodiment depicted in FIG. 3, a plurality of network access points (APs) 350 can operate as the multi-link roaming logic in a distributed manner or may have one specific device operate as the multi-link roaming logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the multi-link roaming logic may be integrated within another network device. In the embodiment depicted in FIG. 3, a wireless LAN controller (WLC) 330 may have an integrated multi-link roaming logic that the WLC 330 can use to monitor or control power consumption of the APs 335 that the WLC 330 is connected to, either wired or wirelessly. In still more embodiments, a personal computer 325 may be utilized to access and/or manage various aspects of the multi-link roaming logic, either remotely or within the network itself. In the embodiment depicted in FIG. 3, the personal computer 325 communicates over the communication network 320 and can access the multi-link roaming logic of the servers 310, or the network APs 350, or the WLC 330.

Although a specific embodiment for various environments that the multi-link roaming logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the multi-link roaming logic may be provided as a device or software separate from the WLC 330 or the multi-link roaming logic may be integrated into the WLC 330. The elements depicted in FIG. 3 may also be interchangeable with other elements of FIGS. 1-2 and FIGS. 4-10 as required to realize a particularly desired embodiment.

Referring to FIG. 4, a conceptual illustration of a wireless network environment with a plurality of access points suitable for roaming in accordance with various embodiments of the disclosure is shown. In many embodiments, the wireless network environment may be floorplan, such as the floorplan 400 shown in the embodiment of FIG. 4. The exemplary floorplan 400 may comprise a variety of office structures like partitions and related objects like, for example, workstations 435, 445, and 455. Also present in the embodiment depicted in FIG. 4 are wireless APs 410, 411, 412, 413, 414, 415, 416, and 417. The wireless APs 410, 411, and 412 are shown as active (shaded), while wireless APs 413, 414, 415, 416, and 417 are inactive (no shade). Someone is working at workstation 445 and two of the nearest APs 411 and 412 may be active to provide network coverage.

Worker 430 is shown entering the office area represented by floorplan 400. In various embodiments, worker 430 may have an end user device, client device, or other mobile wireless device on their person that may have been sensed by and interact with wireless AP 410 to connect and transmit data. If the worker 430 goes to workstation 455 and starts working, a nearby AP like wireless AP 413 may become more viable to connect to, and create a roaming situation. In such a circumstance, wireless AP 410 may generate a recommendation for the end user device of worker 430 to initiate a connection with wireless AP 413. If an application running on the end user device has a specific need, the recommendation provided by the wireless AP 410 may change in order to comply with the needs of that application or device. These needs can be encapsulated within an objective function that can be generated by the wireless AP 410 or the end user device. In these embodiments, it is obvious to those skilled in the art that roaming conditions can change based on the movements of network devices within a wireless network environment.

Although a specific embodiment for a wireless network environment with a plurality of access points suitable for roaming and suitable for carrying out the various steps, processes, methods, and operations described herein is discussed with respect to FIG. 4, any of a variety of systems and/or processes may be utilized in accordance with embodiments of the disclosure. For example, X. The elements depicted in FIG. 4 may also be interchangeable with other elements of FIGS. 1-3 and FIGS. 5-10 as required to realize a particularly desired embodiment.

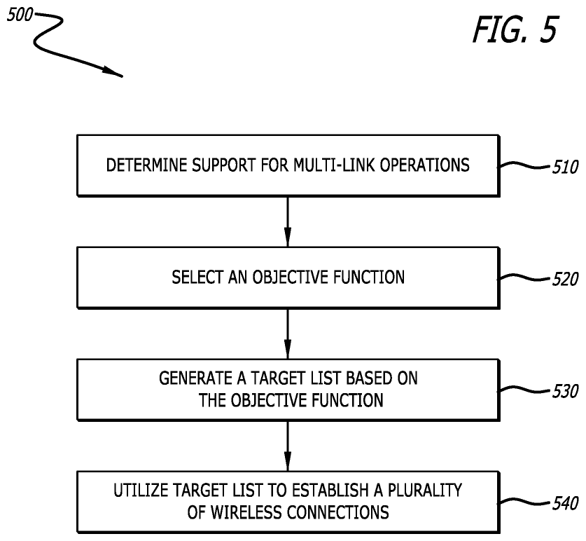

Referring to FIG. 5, a flowchart depicting a process 500 for multi-link roaming in accordance with various embodiments of the disclosure is shown. In many embodiments, the process 500 can determine support for multi-link operations (block 510). In certain embodiments, this can be done through one or more beacon frames. Beacon frames are periodic broadcast messages transmitted by APs to announce their presence and advertise network parameters to nearby client devices. These frames contain essential information such as the network's SSID, supported data rates, security settings, and beacon interval. To signal support for multi-link operation, APs include an extended capabilities element within their beacon frames. The extended capabilities element is a field within the beacon frame's payload that conveys additional capabilities and features supported by the AP, including multi-link support.

In some embodiments, the support can be indicated through one or more extended capabilities elements. Within the extended capabilities element, specific bits or fields are allocated to indicate the AP's support for various features, including multi-link operation. APs set the relevant bit or flag within this element to indicate that they are capable of establishing and managing multiple simultaneous connections with compatible client devices. When nearby wireless devices receive the beacon frame, they parse the extended capabilities element to extract information about the AP's supported features, including multi-link support.

In a number of embodiments, the process 500 can select an objective function (block 520). An objective function can be related to the desire of a network device, such as an end user device, wireless device, or the like, and/or an application on that network device transferring or receiving data over the network. The objective function can be related to the number of links and/or access points (APs) that the network device should connect to. For example, the objective function can desire a roaming strategy to deliver a high-speed AP-to-AP roaming, which requires a multi-AP MLO setup. In another example, the roaming strategy can be designed for a slow speed, higher bandwidth roaming, which requires a single AP, multi-radio MLO setup. In yet another example, the roaming strategy may desire a high degree of upload and download traffic symmetry, which can be realized through a multi-AP, but single transceiver radio mode.

In more embodiments, the process 500 can generate a target list based on the objective function (block 530). In various embodiments, the target list can refer to a compiled set of access points (APs) that a roaming-capable device considers as potential candidates for association when it decides to roam from its current AP. This list typically includes APs within the device's vicinity that are detected during periodic scanning or beacon frame reception. The target AP list serves as a reference for the device to determine the most suitable AP to roam to. This list can be modified based on the objective function to best deliver the desired roaming strategy.

In further embodiments, the process 500 can utilize a target list establish a plurality of wireless connections (block 540). Often, this target list is modified and/or weighted based on the objective function. The network device may request for a recommendation from the target list, or in certain embodiments, the process 500 can broadcast or transmit unsolicited a recommendation for roaming in response to one or more roaming events occurring. The network device can subsequently utilize this recommendation to establish one or more network connections during roaming.

Although a specific embodiment for multi-link roaming suitable for carrying out the various steps, processes, methods, and operations described herein is discussed with respect to FIG. 5, any of a variety of systems and/or processes may be utilized in accordance with embodiments of the disclosure. For example, the objective function can be generated by the network device, while in some embodiments, the process 500 can generate the objective function based on various available data, such as current network traffic usage and historical data. The elements depicted in FIG. 5 may also be interchangeable with other elements of FIGS. 1-4 and FIGS. 6-10 as required to realize a particularly desired embodiment.

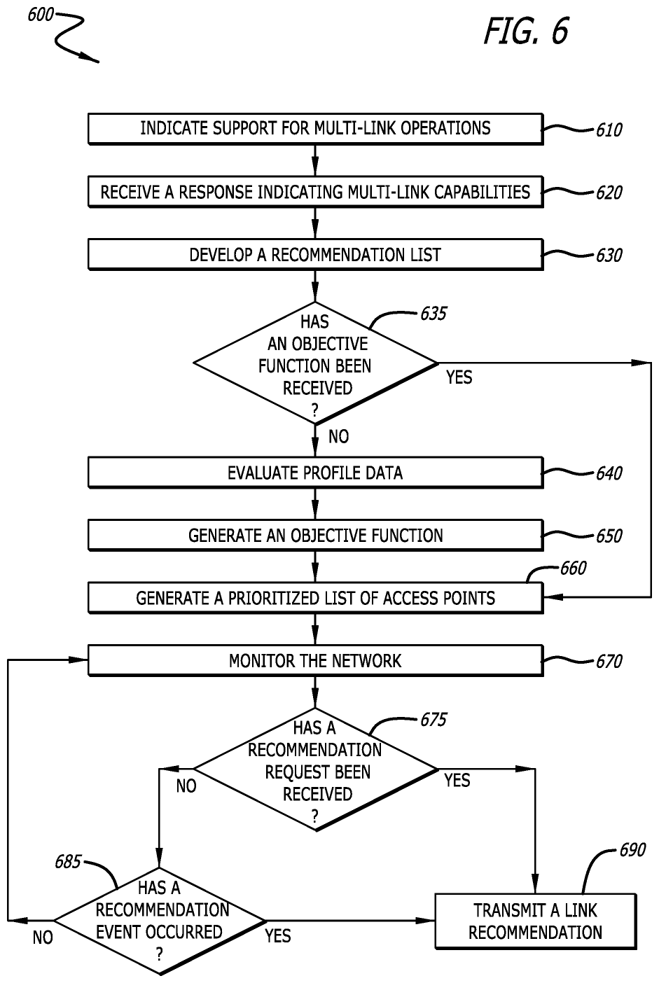

Referring to FIG. 6, a flowchart depicting a process 600 for access point multi-link roaming management in accordance with various embodiments of the disclosure is shown. In many embodiments, the process 600 can indicate support for multi-link operations (block 610). The indication can be transmitted to various devices, such as through a beacon frame or other sounding process.

In a number of embodiments, the process 600 can receive a response indicating multi-link capabilities (block 620). The response can be received from a network device that is attempting to associate with the process 600. In more embodiments, the response can be from a response frame, and can be done through modifying an extended capabilities element within one or more data packets.

In more embodiments, the process 600 can develop a recommendation list (block 630). Based on the available data, the process 600 can determine a set of roaming possibilities that exist. As shown below, this recommendation list can be generated prior to receiving an objective function. However, in some embodiments, the process 600 may skip developing a recommendation list prior to receiving an objective function.

In further embodiments, the process 600 can determine if an objective function has been received (block 635). This objective function can be a completed function that can be parsed and executed. In some embodiments, the objective function is formatted as data related to an objective function that allows for the completion or generation of an objective function to be determined.

If it is determined that the process 600 has received an objective function, the process 600 may further generate a prioritized list of access points (block 660). However, if it is determined that an objective function has not been received, then certain embodiments can evaluate profile data (block 640). As discussed in more detail below, profile data can include various data that can indicate preferences associated with a network device, or an application being executed by the network device. In certain embodiments, other types of data may be evaluated, such as historical data.

In additional embodiments, the process 600 can generate an objective function (block 650). As discussed above, an objective function may be generated based on a derived roaming strategy that is either desired by the network device or is determined based on evaluated data associated with the network device. The objective function can be dynamically set, such that it may be re-evaluated after one or more events, such as an expiration of time, or a change in telemetry data, etc.

In still more embodiments, the process 600 can generate a prioritized list of access points (block 660). The prioritized list of access points can be, in some embodiments, a modified recommendation list that adjusts one or more weights, or priorities of recommended roaming access points based on the objective function(s). In certain embodiments, the process 600 can avoid generating a separate prioritized list of access points, and may simply re-adjust, modify, or otherwise change the previously generated recommendation list.

In yet further embodiments, the process 600 can monitor the network (block 670). This monitoring can include evaluating telemetry data and/or changes in telemetry data, such as data being uploaded, or downloaded. In some embodiments, the types of data packets, such as headers, which can indicate application usage, can be monitored for changes.

In various embodiments, the process 600 can determine if a recommendation request has been received (block 675). The recommendation request can be sent from a network device. In certain embodiments, the recommendation request can be requested from an external or cloud-based device/service.

If a recommendation request has not been received, the process 600 can further determine if a recommendation event has occurred (block 685). The recommendation event can be anything that may require the transmission of a recommendation. This may include any indication that a wireless device, for example, is nearing the boundary of the current access point signal area. In other embodiments, the recommendation event may be the expiration of time, or the adjustment of data types/traffic being sent and/or received by the network device.

If a recommendation event has not occurred, the process 600 can again monitor the network (block 670). However, if it is determined that a recommendation event has occurred, or if a recommendation request has been received, the numerous embodiments can transmit a link recommendation (block 690). The transmission can be sent directly to the network device that it is directed to. However, in certain embodiments, the transmission can be broadcast out over a network, or portion of the network, where the network device may gather and/or parse to receive the link recommendation.

Although a specific embodiment for access point multi-link roaming management suitable for carrying out the various steps, processes, methods, and operations described herein is discussed with respect to FIG. 6, any of a variety of systems and/or processes may be utilized in accordance with embodiments of the disclosure. For example, in some embodiments, a determination of recommendation events occurring may not happen such that the process 600 only responds to direct requests of link recommendations. The elements depicted in FIG. 6 may also be interchangeable with other elements of FIGS. 1-5 and FIGS. 7-10 as required to realize a particularly desired embodiment.

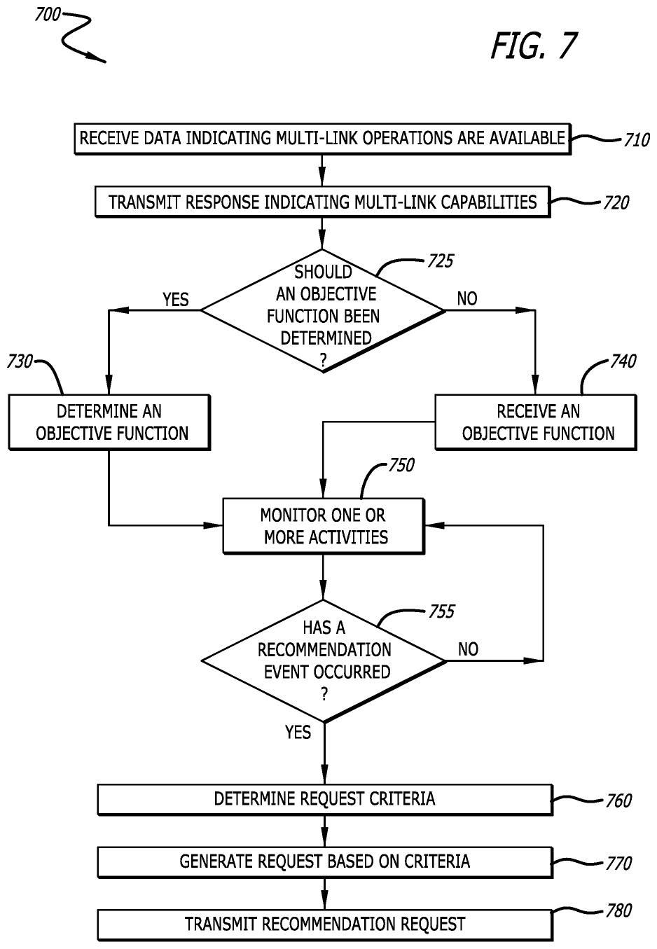

Referring to FIG. 7, a flowchart depicting a process 700 for end user device multi-link roaming management in accordance with various embodiments of the disclosure is shown. In many embodiments, the process 700 can receive data indicating multi-link operations (MLO) are available (block 710). In various embodiments, this can be done through receiving one or more beacon frames. In more embodiments, the beacon frames can have an extended capabilities element setup to indicate the MLO are available.

In a number of embodiments, the process 700 can transmit a response indicating multi-link capabilities (block 720). This response may be formatted within a response frame. In additional embodiments, the response frame may itself have an extended capabilities element modified to indicate multi-link capabilities.

In more embodiments, the process 700 can determine if an objective function should be determined (block 725). In various embodiments, the process 700 may be configured to not generate objective functions. In certain embodiments, the process 700 may conversely be configured to generate objective functions for itself. If it is determined that an objective function is needed, than certain embodiments of the process 700 can determine an objective function (block 730). As described above, the objective function can be determined by analyzing the needs of various data traffic patterns and/or application needs.

However, if it is determined that an objective function is not needed, then various embodiments of process 700 can receive an objective function (block 740). In some embodiments, the objective function can be received from another network device, such as an access point (AP). In further embodiments, the objective function can be received from another controlling device, such as a wireless local area network controller, or a cloud-based network administration service, etc.

In response to either the process 700 determining an objective function, or receiving an objective function, some embodiments of the process 700 can monitor one or more activities (block 750). This monitoring can include evaluating telemetry data and/or changes in telemetry data, such as data being uploaded, or downloaded. In some embodiments, the types of data packets, such as headers, which can indicate application usage, can be monitored for changes.

In additional embodiments, the process 700 can determine if a recommendation event has occurred (block 755). The recommendation event can be anything that may require the transmission of a recommendation request. This may include any indication that the process 700, for example, is nearing the boundary of the current access point signal area. In other embodiments, the recommendation event may be the expiration of time, or the adjustment of data types/traffic being sent and/or received by an application.

If no recommendation event has occurred, than various embodiments of the process 700 can again monitor one or more activities (block 750). However, if it is determined that a recommendation event has occurred, then the process 700 can determine request criteria (block 760). The request criteria can be based on the objective function.

In still more embodiments, the process 700 can generate a request based on the criteria (block 770). In various embodiments, the request criteria can be configured to indicate what type of link recommendation is desired based on the objective function. The recommendation request can, in certain embodiments, be formatted into one or more data packets, such as a header, etc.

In further embodiments, the process 700 can transmit a recommendation request (block 780). The transmission can be sent directly to the network device that it is directed to. However, in certain embodiments, the transmission can be broadcast out over a network, or portion of the network, where the network device may gather and/or parse to receive the link recommendation.

Although a specific embodiment for end user device multi-link roaming management suitable for carrying out the various steps, processes, methods, and operations described herein is discussed with respect to FIG. 7, any of a variety of systems and/or processes may be utilized in accordance with embodiments of the disclosure. For example, in certain embodiments, the process 700 may automatically transmit recommendation requests without the need to determine if a recommendation event occurred. The elements depicted in FIG. 7 may also be interchangeable with other elements of FIGS. 1-6 and FIGS. 8-10 as required to realize a particularly desired embodiment.

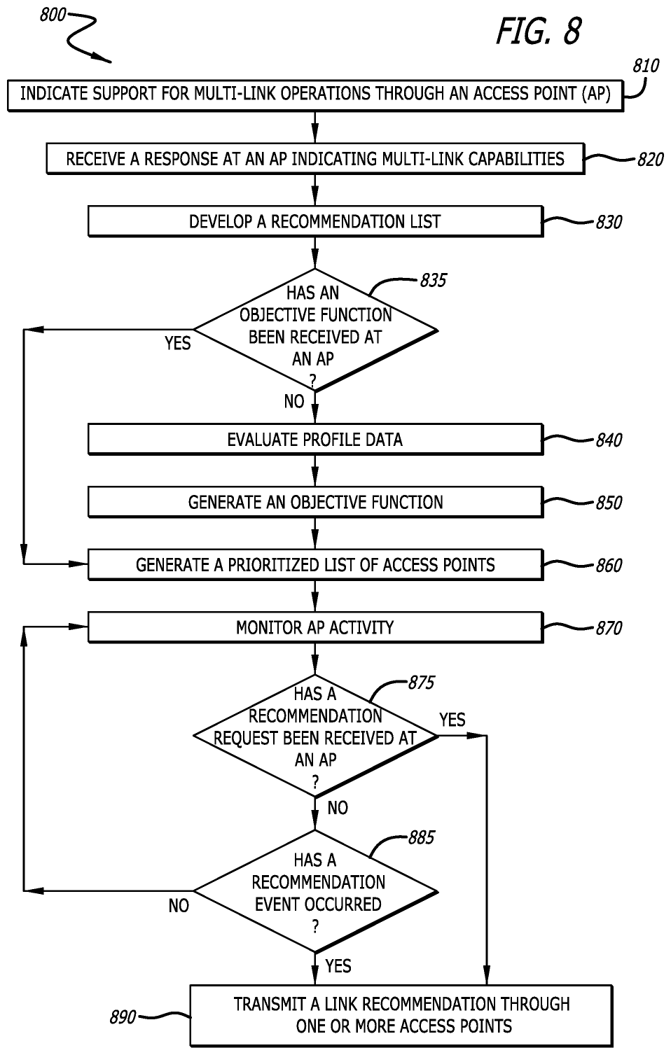

Referring to FIG. 8, a flowchart depicting a process 800 for remote-based multi-link roaming management in accordance with various embodiments of the disclosure is shown. In certain embodiments, the multi-link management may occur at a wireless local area network controller, or through a cloud-based service. In many embodiments, the process 800 can indicate support for multi-link operations through an access point (AP) (block 810). The indication can be transmitted to various devices, such as through a beacon frame or other sounding process.

In a number of embodiments, the process 800 can receive a response at an AP indicating multi-link capabilities (block 820). The response can be received from a network device that is attempting to associate with the process 800. In more embodiments, the response can be from a response frame, and can be done through modifying an extended capabilities element within one or more data packets.

In more embodiments, the process 800 can develop a recommendation list (block 830). Based on the available data, the process 800 can determine a set of roaming possibilities that exist. As shown below, this recommendation list can be generated prior to receiving an objective function. However, in some embodiments, the process 800 may skip developing a recommendation list prior to receiving an objective function.

In additional embodiments, the process 800 can determine if an objective function has been received at an AP (block 835). This objective function can be a completed function that can be parsed and executed. In some embodiments, the objective function is formatted as data related to an objective function that allows for the completion or generation of an objective function to be determined.

If it is determined that the process 800 has received an objective function, the process 800 may further generate a prioritized list of access points (block 860). However, if it is determined that an objective function has not been received, then certain embodiments of the process 800 can evaluate profile data (block 840). As discussed in more detail below, profile data can include various data that can indicate preferences associated with a network device, or an application being executed by the network device. In certain embodiments, other types of data may be evaluated, such as historical data.

In additional embodiments, the process 800 can generate an objective function (block 850). As discussed above, an objective function may be generated based on a derived roaming strategy that is either desired by the network device or is determined based on evaluated data associated with the network device. The objective function can be dynamically set, such that it may be re-evaluated after one or more events, such as an expiration of time, or a change in telemetry data, etc.

In still more embodiments, the process 800 can generate a prioritized list of access points (block 860). The prioritized list of access points can be, in some embodiments, a modified recommendation list that adjusts one or more weights, or priorities of recommended roaming access points based on the objective function(s). In certain embodiments, the process 600 can avoid generating a separate prioritized list of access points, and may simply re-adjust, modify, or otherwise change the previously generated recommendation list.

In yet further embodiments, the process 800 can monitor AP activity (block 870). This monitoring can include evaluating telemetry data and/or changes in telemetry data in the AP, such as data being uploaded, or downloaded. In some embodiments, the types of data packets, such as headers, which can indicate application usage, can be monitored for changes.

In various embodiments, the process 800 can determine if a recommendation request has been received at an AP (block 875). The recommendation request can be sent from a network device. In certain embodiments, the recommendation request can be requested from an external or cloud-based device/service.

If no recommendation request has not been received, the process 800 can further determine if a recommendation event has occurred (block 885). The recommendation event can be anything that may require the transmission of a recommendation. This may include any indication that a wireless device, for example, is nearing the boundary of the current access point signal area. In other embodiments, the recommendation event may be the expiration of time, or the adjustment of data types/traffic being sent and/or received by the network device.

If a recommendation event has not occurred, the process 800 can again monitor the network (block 870). However, if it is determined that a recommendation event has occurred, or if a recommendation request has been received, the numerous embodiments can transmit a link recommendation through one or more APs (block 890). The transmission can be sent directly to the network device that it is directed to. However, in certain embodiments, the transmission can be broadcast out over a network, or portion of the network, where the network device may gather and/or parse to receive the link recommendation.

Although a specific embodiment for remote-based multi-link roaming management suitable for carrying out the various steps, processes, methods, and operations described herein is discussed with respect to FIG. 8, any of a variety of systems and/or processes may be utilized in accordance with embodiments of the disclosure. For example, the process 800 can be operated on the local network, or may be done remotely via one or more cloud-based services devices, etc. The elements depicted in FIG. 8 may also be interchangeable with other elements of FIGS. 1-7 and FIGS. 9-10 as required to realize a particularly desired embodiment.

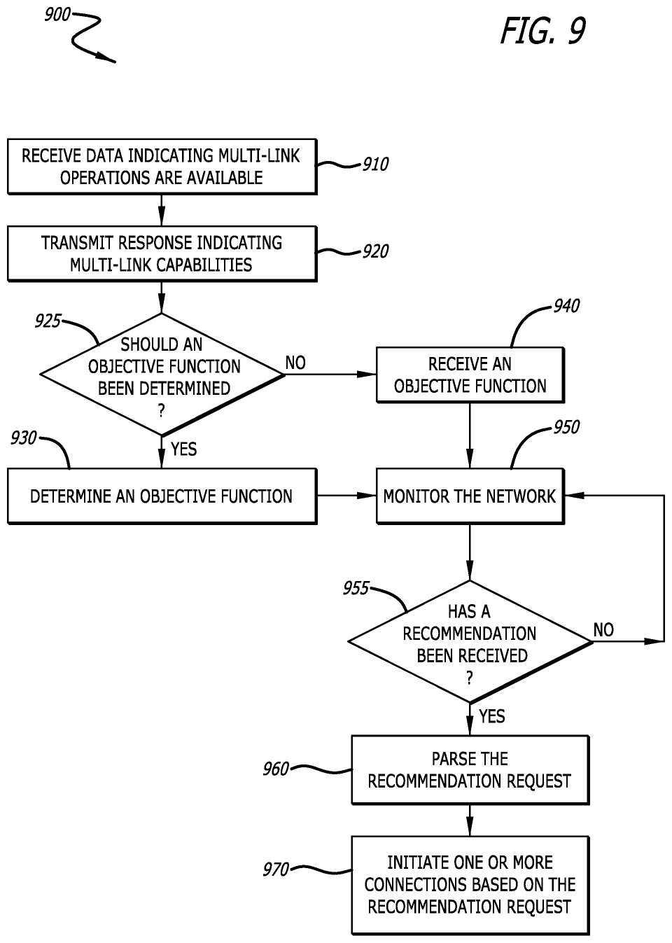

Referring to FIG. 9, a flowchart depicting a process 900 for roaming recommendation processing in accordance with various embodiments of the disclosure is shown. In many embodiments, the process 900 can receive data indicating multi-link operations are available (block 910). In various embodiments, this can be done through receiving one or more beacon frames. In more embodiments, the beacon frames can have an extended capabilities element setup to indicate the MLO are available.

In a number of embodiments, the process 900 can transmit a response indicating multi-link capabilities (block 920). This response may be formatted within a response frame. In additional embodiments, the response frame may itself have an extended capabilities element modified to indicate multi-link capabilities.

In more embodiments, the process 900 can determine if an objective function should be determined (block 925). In various embodiments, the process 900 may be configured to not generate objective functions. In certain embodiments, the process 900 may conversely be configured to generate objective functions for itself. If it is determined that an objective function is needed, than certain embodiments of the process 900 can determine an objective function (block 930). As described above, the objective function can be determined by analyzing the needs of various data traffic patterns and/or application needs.

However, if it is determined that an objective function is not needed, then various embodiments of process 900 can receive an objective function (block 940). In some embodiments, the objective function can be received from another network device, such as an access point (AP). In further embodiments, the objective function can be received from another controlling device, such as a wireless local area network controller, or a cloud-based network administration service, etc.

In response to either the process 900 determining an objective function, or receiving an objective function, some embodiments of the process 900 can monitor one or more activities (block 950). This monitoring can include evaluating telemetry data and/or changes in telemetry data, such as data being uploaded, or downloaded. In some embodiments, the types of data packets, such as headers, which can indicate application usage, can be monitored for changes.

In additional embodiments, the process 900 can determine if a recommendation has been received (block 955). The recommendation event can be anything that may require the transmission of a recommendation request. This may include any indication that the process 900, for example, is nearing the boundary of the current access point signal area. In other embodiments, the recommendation event may be the expiration of time, or the adjustment of data types/traffic being sent and/or received by an application.

If no recommendation event has occurred, than various embodiments of the process 900 can again monitor one or more activities (block 950). However, if it is determined that a recommendation has been received, then the process 900 can parse the recommendation request (block 960). Parsing may include taking the raw data and transforming it into a format that can be executed on. In certain embodiments, parsing can include adding it to a queue for processing or analyzing the data contained within the recommendation.

In still more embodiments, the process 900 can initiate one or more connections based on the recommendation request (block 970). In certain embodiments, the one or more connections comprise roaming connections. The roaming connections can be configured based on the objective function associated with the process 900.

Although a specific embodiment for roaming recommendation processing suitable for carrying out the various steps, processes, methods, and operations described herein is discussed with respect to FIG. 9, any of a variety of systems and/or processes may be utilized in accordance with embodiments of the disclosure. For example, upon initiating a new connection, the process 900 may start again or may continue to monitor the network. The elements depicted in FIG. 9 may also be interchangeable with other elements of FIGS. 1-8 and FIG. 10 as required to realize a particularly desired embodiment.

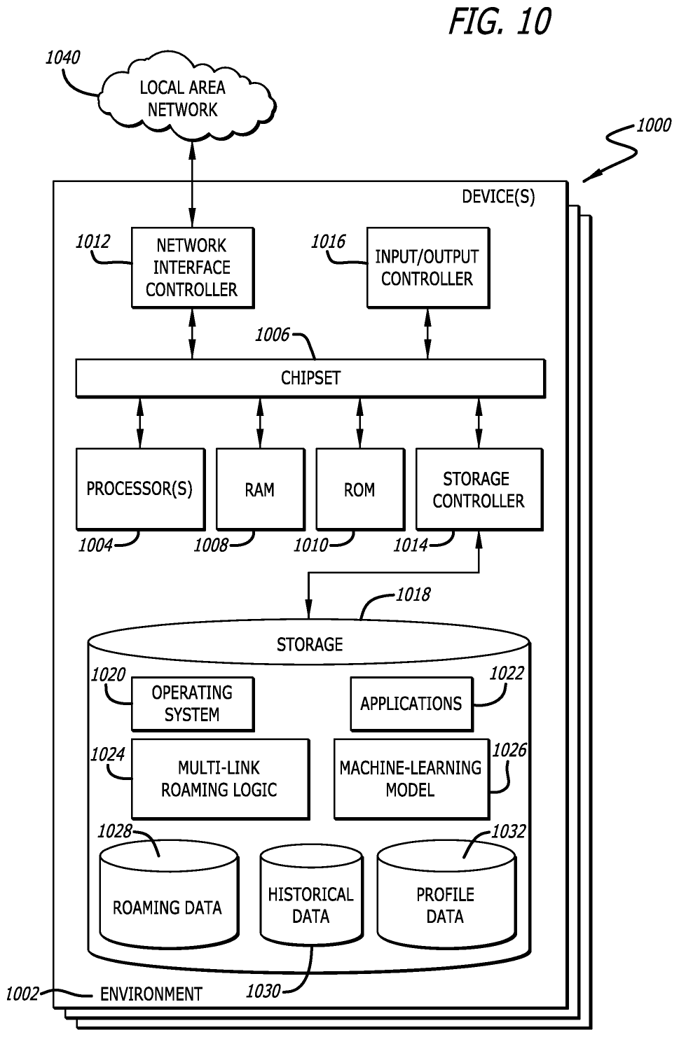

Referring to FIG. 10, a conceptual block diagram of a device 1000 suitable for configuration with a multi-link roaming logic, in accordance with various embodiments of the disclosure is shown. The embodiment of the conceptual block diagram depicted in FIG. 10 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many non-limiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In many further embodiments, the device 1000 may include a multi-link roaming logic 1024. The multi-link roaming logic 1024 can be configured to perform one or more of the various steps, processes, operations, and/or other methods that are described above. Often, the multi-link roaming logic 1024 can be a set of instructions stored within a non-volatile memory that, when executed by the controller(s)/processor(s) 1004 can carry out these steps, etc. In some embodiments, the multi-link roaming logic 1024 may be a client application that resides on a network-connected device, such as, but not limited to, a server, switch, personal or mobile computing device in a single or distributed arrangement.

In some embodiments, roaming data 1028 can encompass information exchanged between a mobile device and various access points (APs) as the device moves between different areas covered by the same or different wireless networks. Roaming is a crucial aspect of wireless communication, especially in scenarios where users need seamless connectivity while transitioning between different coverage areas. Roaming data can encompass several key elements that facilitate this seamless transition and ensure uninterrupted connectivity for users.

First and foremost, roaming data 1028 can include information about available wireless networks and their respective access points. This information helps a mobile device identify and authenticate with nearby APs as it moves within the coverage range of different networks. In some embodiments, roaming data 1028 may also typically include network identifiers (SSIDs), security parameters (such as encryption keys or authentication methods), and signal strength indicators. By continuously scanning for available networks and evaluating their signal strength and quality, the device can make informed decisions about when to switch between APs to maintain the best possible connection quality.

In some embodiments, a component of roaming data 1028 can include data related to a handover process. Handover refers to the process of transferring an ongoing communication session from one AP to another as a mobile device moves out of the coverage range of the current AP and into the coverage range of another. Roaming data 1028 may further include signaling messages exchanged between the device and the network infrastructure to facilitate this handover process seamlessly. These messages typically include requests for association or reassociation with a new AP, negotiation of connection parameters, and notifications to update network routing tables and maintain session continuity.

Additionally, roaming data 1028 may include information related to network policies and preferences configured on the mobile device or managed by the network operator. For example, a device may prioritize certain networks over others based on predefined criteria such as security level, signal strength, or available bandwidth. Roaming data 1028 may allow the device to apply these preferences when selecting an AP to associate with, ensuring that it connects to the most suitable network available in its vicinity.

Finally, roaming data 1028 may, in certain embodiments, encompass mechanisms for optimizing the handover process to minimize service disruptions and latency. This may involve techniques such as predictive handover, where the device anticipates potential handover events based on its movement trajectory and preempts them by initiating the handover process proactively before signal degradation occurs. By exchanging relevant information about neighboring APs and their respective coverage areas, roaming data enables the device to make timely handover decisions and maintain seamless connectivity even in dynamic and rapidly changing environments.

In various embodiments, historical data 1030 can comprise information collected and stored about the past behavior and performance of devices as they roam within a network environment. This historical data 1030 may serve various purposes, including network optimization, troubleshooting, and enhancing user experience. By analyzing past roaming patterns and performance metrics, network administrators and engineers can gain valuable insights into the behavior of wireless devices and make informed decisions to improve network efficiency and reliability.

One aspect of historical data 1030 is the record of device roaming patterns. This includes information about the frequency of roaming events, the duration of time spent connected to each AP, and the sequence of APs visited by a device during its movement within the network coverage area. By analyzing these roaming patterns over time, network operators or logics can identify trends and patterns in device behavior, such as areas with high roaming activity or instances of frequent handover failures. This insight allows them to optimize AP placement, adjust coverage overlap, and fine-tune roaming parameters to enhance the overall roaming experience for users.

Moreover, historical data 1030 may include performance metrics associated with roaming events. These metrics can encompass parameters such as signal strength, throughput, latency, and packet loss experienced by devices before, during, and after handover between APs. By correlating roaming events with performance data, network administrators can identify potential bottlenecks, interference sources, or coverage gaps that may impact the quality of service for roaming devices. This information enables them to proactively address issues and optimize network settings to ensure seamless connectivity and optimal performance for users as they roam within the network.

Another aspect of historical data 1030 in wireless networking is the documentation of roaming-related events and their outcomes. This includes records of handover attempts, success rates, and any associated error codes or messages logged by network infrastructure components during the roaming process. By analyzing these event logs retrospectively, network operators can diagnose roaming-related issues, troubleshoot connectivity problems, and implement corrective measures to mitigate recurring issues and improve roaming reliability. Historical data also serves as a valuable resource for post-event analysis and root cause identification, helping to refine network configurations and policies to prevent similar issues in the future.

Furthermore, historical data 1030 may include user-specific information such as roaming preferences, device capabilities, and authentication credentials used during previous roaming sessions. By maintaining profiles of individual users and their associated devices, network operators can personalize roaming experiences, enforce access policies, and optimize network resources based on user-specific requirements and usage patterns. This personalized approach to roaming management enhances user satisfaction and productivity by ensuring that each device seamlessly connects to the most suitable APs based on its unique characteristics and preferences.

In a number of embodiments, profile data 1032 can comprise a range of information related to individual devices and their associated preferences, capabilities, and usage patterns. Profile data 1032 can play a role in optimizing the roaming experience by enabling network administrators to tailor network settings and policies to meet the specific needs of each device and user. One aspect of profile data 1032 is device-specific information, including hardware characteristics, firmware versions, and supported communication standards. This data helps network administrators identify compatible APs and configure appropriate connection parameters to ensure seamless interoperability between devices and network infrastructure. For example, profile data 1032 may indicate whether a device supports specific Wi-Fi standards (e.g., 802.11ac, 802.11ax) or advanced features (e.g., MU-MIMO, beamforming), allowing administrators to provision resources accordingly and deliver optimal performance for each device category.

Furthermore, profile data 1032 may include user-specific preferences and access policies, such as preferred networks, authentication credentials, and Quality of Service (QOS) settings. By maintaining profiles for individual users or groups, network administrators can enforce access controls, prioritize network resources, and apply traffic shaping policies based on user roles, privileges, or subscription plans. For instance, profile data 1032 may specify bandwidth allocation limits for different user categories (e.g., guests, employees) or prioritize traffic from critical applications (e.g., voice over IP, video streaming) based on user-defined preferences or organizational requirements.

Additionally, profile data 1032 may encompass historical usage patterns and roaming behavior for each device or user. This information can help network administrators or logics anticipate future connectivity needs, predict roaming events, and optimize network configurations to accommodate peak usage periods or recurring patterns of activity. By analyzing historical data, administrators can identify trends, outliers, or anomalies in device behavior and implement proactive measures to address potential performance issues or capacity constraints before they impact user experience.

Moreover, profile data 1032 may include location-based information, such as geospatial coordinates or proximity to specific APs or network resources. This data may enable administrators to implement location-aware services, such as targeted advertising, indoor navigation, or asset tracking, based on the real-time or historical positions of wireless devices within the network coverage area. By leveraging location-based profiling, administrators can deliver personalized experiences, improve operational efficiency, and enhance security by enforcing access controls or geofencing policies in designated areas.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the telemetry data 1028, the power topology data 1030, and the station data 1032. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with the multi-link roaming logic for carrying out the various steps, processes, methods, and operations described herein is discussed with respect to FIG. 10, any of a variety of systems and/or processes may be utilized in accordance with embodiments of the disclosure. For example, the device 1000 may be in a virtual environment such as a cloud-based network administration suite, or it may be distributed across a variety of network devices or APs. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one wireless transceiver configured to provide access to a network; and
a memory communicatively coupled to the processor, wherein the memory comprises a multi-link roaming logic that is configured to:
indicate support for multi-link operations to a network device;
receive a response from the network device indicating multi-link capabilities;
develop a recommendation list for the network device;
evaluate one or more network conditions; and
generate an objective function associated with the network device.

2. The device of claim 1, wherein the multi-link roaming logic is further configured to determine that a roaming recommendation is required.

3. The device of claim 2, wherein the determination of the roaming recommendation is based on receiving a request for a recommendation.

4. The device of claim 3, wherein the request for a roaming recommendation is received from the network device.

5. The device of claim 3, wherein the determination of the roaming recommendation is based on a recommendation event occurring.

6. The device of claim 5, wherein the roaming recommendation event is detecting a change in a movement of the network device.

7. The device of claim 1, wherein the multi-link roaming logic is configured to receive the objective function from the network device.

8. The device of claim 1, wherein indicating support for multi-link operations occurs by modifying an extended capabilities element within a beacon frame.

9. The device of claim 1, wherein the roaming recommendation list is a weighted target access point (AP) list.

10. The device of claim 9, wherein the weighted target access point AP list is developed based on one or more criteria.

11. The device of claim 10, wherein the one or more criteria comprises at least one of: link reliability, maximized throughput, roaming latency, band constraints, frame jitter constraints, or frame delay constraints.

12. The device of claim 1, wherein the objective function is configured to indicate one or more roaming strategies.

13. The device of claim 12, wherein the one or more roaming strategies are associated with a selection of links and access points during a roaming process.

14. A device, comprising:
a processor;
at least one network interface configured to provide access to a network; and
a memory communicatively coupled to the processor, wherein the memory comprises a multi-link roaming logic that is configured to:
receive an indication for multi-link operations from a network device;
transmit a response indicating multi-link capabilities;
generate an objective function;
transmit the objective function to the network device;
request a roaming recommendation; and
receive a roaming recommendation.

15. The device of claim 14, wherein the roaming recommendation is based on at least the objective function.

16. The device of claim 14, wherein the roaming recommendation is configured to indicate one or more links to establish a network connection to.

17. The device of claim 14, wherein the objective function is configured to indicate if roaming recommendations should prioritize multi-link operations or single-link operations.

18. The device of claim 14, wherein the objective function is configured to indicate if roaming recommendations should prioritize single access point connections or multi-access point connections.

19. The device of claim 14, wherein indicating multi-link capabilities occurs by modifying an extended capabilities element within a response frame.

20. A method of managing multi-link wireless network connections, comprising:
indicating support for multi-link operations to a network device;
receiving a response from the network device indicating multi-link capabilities;
developing a recommendation list for the network device;
evaluating one or more network conditions;
receiving an objective function from with the network device; and
modifying one or more recommendations provided from the recommendation list in response to the received objective function.
